(19) United States
(12) Patent Application Publication
(10) Pub. No.: US 2006/0192756 A1
(43) Pub. Date: Aug. 31, 2006

(54) Computer mouse with capability to control an electronic therapy device

(75) Inventors: Liang Ming Cao, Hefei (CN); Eric Chen, Saint Louis, MO (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Hefie Jianqiao Sci-Tech Development Co., Ltd., Hefei (CN)

(21) Appl. No.: 11/066,035

(22) Filed: Feb. 25, 2005

(51) Int. Cl. G09G 5/08

(52) U.S. Cl. 345/163

(57) ABSTRACT

A computer mouse with capability to control an electronic therapy device. In one embodiment, the computer mouse includes a main body, a power circuit, and a cursor control circuit electrically coupled to the power circuit. The computer mouse further includes a function module electrically coupled to the power circuit for generating a series of electronic pulses, and an electronic therapy device having a plurality of electrodes, and pullably plugged into the computer mouse main body such that when activated, the electronic therapy device is electrically coupled to the function module, and a series of electronic pulses is transmitted from the at least one output port of the function module to at least one of the plurality of electrodes of the electronic therapy device so as to cause massage stimuli to a target of interest on which the electronic therapy device is placed.

### FIELD OF THE INVENTION

The present invention generally relates to a computer mouse and, in particular, to a computer mouse with capability to control an electronic therapy device to provide massage stimuli to a user of the computer mouse.

### BACKGROUND OF THE INVENTION

A conventional computer mouse corresponds to a hand-held, button-activated input device that when rolled and/or moved along a flat surface directs an indicator to move correspondingly about a computer screen, or a display, allowing the user to move the indicator freely, as to select operations or manipulate text or graphics.

A computer user may provide input to a computer by actuating an input device including, a computer mouse, a keyboard, etc. Continuous operation of such a device over a substantial period of time may result in fatigue, discomfort, and muscular rigidity. Such fatigue and discomfort may result in absenteeism and/or in decreased productivity. Muscular rigidity may contribute to a variety of concerns. For example, it is believed that muscular rigidity may reduce lymphatic system function. Such reduction in lymphatic system function may reduce the body's ability to effectively remove cellular wastes. Muscular rigidity may also cause muscle spasms, loss of flexibility, and loss of elasticity in the affected muscles. Muscular rigidity in a set of muscles may contribute to muscular tension and fatigue throughout the body. The widespread use of computer input is believed to have contributed to a significant increase in incidences of a repetitive motion stress injuries.

There are continuing efforts to improve the shape, functionality and feel of a computer mouse as to make a user more comfortable and relaxing his/her muscle when operating it. As well known and use widely, the massaging to be useful in curing and relieving muscle stress, it would be desirable to provide massage functions for a computer mouse that allow a user able to choose activation of the massage functions, including adjustable leveling of massaging, and disabling of massaging.

Therefore, a heretofore unaddressed need still exists in the art to address the aforementioned deficiencies and inadequacies.

### SUMMARY OF THE INVENTION

The present invention, in one aspect, relates to a computer mouse with capability to control an electronic therapy device. In one embodiment, the computer mouse includes a main body, a power circuit having a power supply port and a ground port, and a cursor control circuit having a pair of power input ports electrically coupled to the power supply port and the ground port of the power circuit, respectively. In one embodiment, the cursor control circuit is adapted for positioning a cursor of the computer mouse on a display associated with a computer with which the computer mouse communicates.

The computer mouse further includes a function module having a pair of input ports electrically coupled to the power supply port and the ground port of the power circuit, respectively, and at least one output port. The function module is adapted for generating a series of electronic pulses. The cursor control circuit, the power circuit and the function module are disposed inside the main body.

Moreover, the computer mouse includes an electronic therapy device that has a plurality of electrodes and is pullably plugged into the computer mouse main body such that when activated, the electronic therapy device is electrically coupled to the function module, and a series of electronic pulses is transmitted from the at least one output port of the function module to at least one of the plurality of electrodes of the electronic therapy device so as to cause massage stimuli to a target of interest on which the electronic therapy device is placed. The plurality of electrodes are located in predetermined positions in the electronic therapy device so as to determine a pattern of the massage stimuli applied to the target of interest. In one embodiment, the electronic therapy device is formed in a hand-like shape, whereby, in operation, the electronic therapy device simulates massages of a human hand. Additionally, the computer mouse includes means for activating and deactivating the electronic therapy device, means for tuning a frequency of the series of electronic pulses generated by the function module, means for adjusting an intensity of the series of electronic pulses generated by the function module, and means for selecting a pattern of a pattern of the massage stimuli applied to the target of interest.

In another aspect, the present invention relates to a method of controlling an electronic therapy device for a therapy of a user of a computer mouse. The computer mouse includes a main body, a power circuit, and a cursor control circuit electrically coupled to the power circuit, and the electronic therapy device has a plurality of electrodes and is pullably plugged into the main body of the computer mouse. Each of the plurality of electrodes is located in a predetermined position in the electronic therapy device so as to cause a pattern of the massage stimuli. In one embodiment, the method includes the steps of providing a function module electrically coupled to the power circuit of the computer mouse for generating a series of electronic pulses, and activating the electronic therapy device so as to transmit the generated series of electronic pulses from the function module to at least one of the plurality of electrodes of the electronic therapy device to provide massage stimuli to the user on which the electronic therapy device is placed. In one embodiment, the activating step has the step of electrically connecting the electronic therapy device to the function module. Furthermore, the method includes the steps of tuning a frequency of the series of electronic pulses generated by the function module, adjusting an intensity of the series of electronic pulses generated by the function module, and selecting a pattern of a pattern of the massage stimuli applied to the user.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

FIG. 1 shows schematically a perspective view of a computer mouse with capability to control an electronic therapy device according to one embodiment of the present invention.

FIG. 2 shows schematically a block diagram of electronic circuits of the computer mouse as shown in FIG. 1.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The description will be made as to the embodiments of the present invention in conjunction with the accompanying drawings 1-2. In accordance with the purposes of this invention, as embodied and broadly described herein, this invention, in one aspect, relates to a computer mouse with capability to control an electronic therapy device.

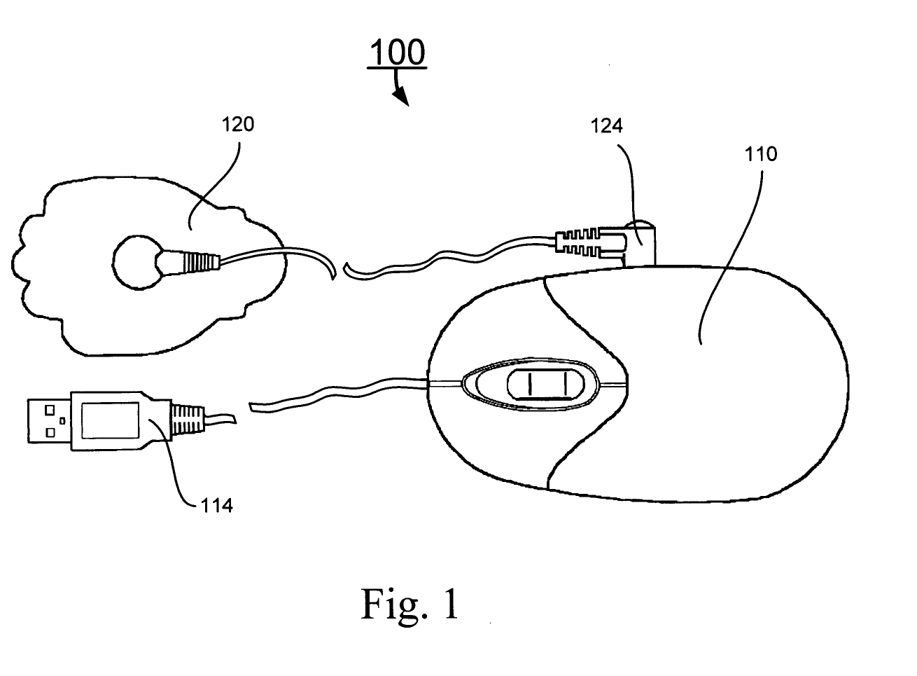

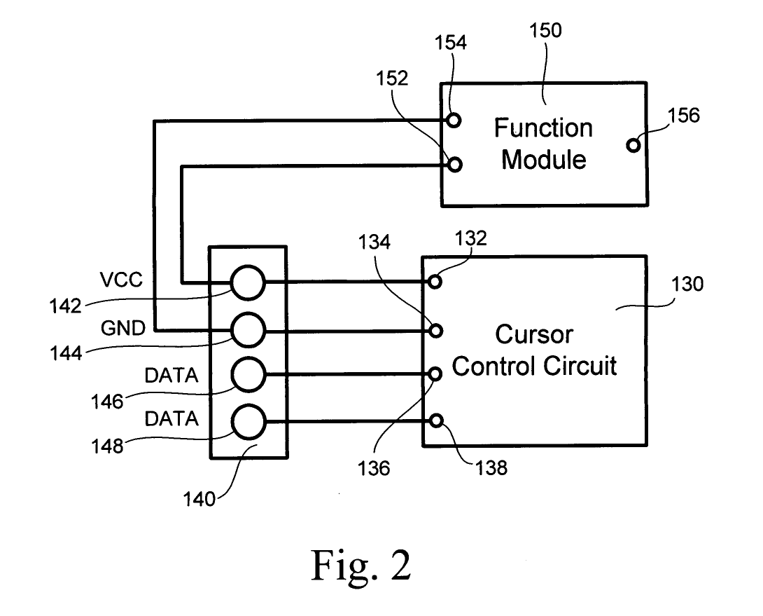

Referring in general to FIGS. 1 and 2, the computer mouse 100 has a main body 110. The main body 110 in one embodiment has a housing. The computer mouse 100 further has a power circuit 140 that has a power supply port 142 and a ground port 144. In one embodiment, the power supply port 142 of the power circuit 140 corresponds to an output port of a voltage at the common collector (hereinafter “VCC”). The power circuit 140 further has a first data port 146 and a second data port 148.

Moreover, the computer mouse 100 has a cursor control circuit 130. The cursor control circuit 130 has a pair of power input ports 132 and 134 that are electrically coupled to the power supply port 142 and the ground port 144 of the power circuit 140, respectively. The cursor control circuit 130 further has a first data port 136 and a second data port 138 that are in communication with the first data port 146 and the second data port 148 of the power circuit 140, respectively. The cursor control circuit 130 is adapted for controlling a cursor position of the computer mouse 100 on a display, or a screen, associated with a computer with which the computer mouse 100 communicates.

Furthermore, the computer mouse 100 has a function module 150. The function module 150 has a pair of input ports 152 and 154 that are electrically coupled to the power supply port 142 and the ground port 144 of the power circuit 140, respectively. The function module 150 also has at least one output port 156. The function module 150 is adapted for generating a series of electronic pulses, which, in operation, is output from the at least one output port 156. In one embodiment, an intensity of the generated series of electronic pulses is adjustable, and a frequency of the generated series of electronic pulses is tunable. The function module 150, in one embodiment, is designed such that the frequency of the generated series of electronic pulses falls into a frequency range that is substantially different from a frequency range of output signals of the cursor control circuit 130. Furthermore, the frequency of the generated series of electronic pulses is lower than the frequency of output signals of the cursor control circuit 130. Accordingly, the generated series of electronic pulses have no electric interference with output signals of the cursor control circuit 130 that is transmitted to the computer for positioning the cursor of the computer mouse 100 on the computer screen.

In one embodiment, the cursor control circuit 130, the power circuit 140 and the function module 150 are received therein the housing of the main body 110.

Additionally, the computer mouse 100 includes an electronic therapy device 120 having a plurality of electrodes. Each of the plurality of electrodes is located in a predetermined position in the electronic therapy device 120. The distribution of the plurality of electrodes over the electronic therapy device 120 causes a pattern of massage stimuli applied to a target of interest of a user of the computer mouse 100. The target of interest can be a shoulder portion, a hand portion, a back portion or other portions of the user. The electronic therapy device 120 is pullably plugged into the computer mouse main body 110. The computer mouse 100 also includes means for activating and deactivating the electronic therapy device 120. In one embodiment, the activating and deactivating means includes a switch disposed at a predetermined position on the main body 110 of the computer mouse 100 (not shown). When the electronic therapy device 120 is activated, it is electrically coupled to the function module 150, and a series of electronic pulses generated by the function module 150 is transmitted from the at least one output port 156 of the function module 150 to at least one of the plurality of electrodes of the electronic therapy device 120 so as to cause massage stimuli to a target of interest of a user of the computer mouse 100 on which the electronic therapy device 120 is placed. The massage stimuli may include stroking, compression, kneading, squeezing or percussion of the target of interest, such as soft body tissues of a user of the computer mouse 100. When the electronic therapy device 120 is deactivated, it is electrically decoupled with the function module 150. Accordingly, none of a series of electronic pulses generated by the function module 150 is transmitted from the at least one output port 156 of the function module 150 to the plurality of electrodes of the electronic therapy device 120. In one embodiment, the electronic therapy device 120 is formed in a hand-like shape, as shown in FIG. 1. In operation, the electronic therapy device 120 simulates massages of a human hand. In one embodiment, the electronic therapy device 120 is made of materials such that the electronic therapy device 120 is flexible. Characteristics of the massage stimuli such as intensity, frequency, location, and pattern of the massage stimuli application may be controlled by a user of the computer mouse 100, a microcontroller or computer. For example, the intensity and frequency of the massage stimuli application can be adjusted by varying the intensity and frequency of a series of electronic pulses generated by the function module 150, respectively. The location and pattern of the massage stimuli application can be chosen by transmitting a series of electronic pulses generated by the function module 150 selectively to a specific electrode(s) of the plurality of electrodes of the electronic therapy device 100. In one embodiment, the computer mouse 100 has at least one of means for adjusting the intensity, means for tuning the frequency, and means for selecting the pattern of the massage stimuli applied to soft body tissues of a user of the computer mouse 100.

The present invention, in another aspect, relates to a method of controlling an electronic therapy device for a therapy of a user of a computer mouse. The computer mouse includes a main body, a power circuit, and a cursor control circuit electrically coupled to the power circuit, and the electronic therapy device has a plurality of electrodes and is pullably plugged into the main body of the computer mouse. The plurality of electrodes are located in predetermined positions in the electronic therapy device so as to cause a pattern of massage stimuli applied to a target of interest. In one embodiment, the method includes the steps of providing a function module that is electrically coupled to the power circuit of the computer mouse for generating a series of electronic pulses, and activating the electronic therapy device so as to transmit the generated series of electronic pulses from the function module to at least one of the plurality of electrodes of the electronic therapy device to cause massage stimuli to the user on which the electronic therapy device is placed. In one embodiment, the activating step comprises the step of electrically connecting the electronic therapy device to the function module. Furthermore, the method includes the step of tuning a frequency of the series of electronic pulses generated by the function module so as to tuning a frequency of the massage stimuli applied to the user. Moreover, the method includes the step of adjusting an intensity of the series of electronic pulses generated by the function module so as to adjust an intensity of the massage stimuli applied to the target of interest. Additionally, the method includes the step of selecting a pattern of a pattern of the massage stimuli applied to the user.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer mouse 100 with capability to control an electronic therapy device, comprising:
a. a main body 110;
b. a power circuit 140 having a power supply port 142 and a ground port 144;
c. a cursor control circuit 130 having a pair of power input ports 132 and 134 electrically coupled to the power supply port 142 and the ground port 144 of the power circuit 140, respectively;
d. a function module 150 having a pair of input ports 152 and 154 electrically coupled to the power supply port 142 and the ground port 144 of the power circuit 140, respectively, and at least one output port 156, the function module 150 adapted for generating a series of electronic pulses; and
e. an electronic therapy device 120 having a plurality of electrodes, and pullably plugged into the computer mouse main body 110 such that when activated, the electronic therapy device 120 is electrically coupled to the function module 150, and a series of electronic pulses is transmitted from the at least one output port 156 of the function module 150 to at least one of the plurality of electrodes of the electronic therapy device 120 so as to cause massage stimuli to a target of interest on which the electronic therapy device 120 is placed,
wherein the cursor control circuit 130, the power circuit 140 and the function module 150 are disposed inside the main body 110.

2. The computer mouse of claim 1, wherein the cursor control circuit 130 is adapted for positioning a cursor of the computer mouse 100 on a display associated with a computer with which the computer mouse 100 communicates.

3. The computer mouse of claim 1, further comprising means for activating and deactivating the electronic therapy device 120.

4. The computer mouse of claim 1, further comprising means for tuning a frequency of the series of electronic pulses generated by the function module 150.

5. The computer mouse of claim 1, further comprising means for adjusting an intensity of the series of electronic pulses generated by the function module 150.

6. The computer mouse of claim 1, wherein the plurality of electrodes are located in predetermined positions in the electronic therapy device 120 so as to cause a pattern of the massage stimuli applied to the target of interest.

7. The computer mouse of claim 6, wherein the electronic therapy device 120 is formed in a hand-like shape, whereby, in operation, the electronic therapy device 120 simulates massages of a human hand.

8. The computer mouse of claim 7, further comprising means for selecting a pattern of the massage stimuli applied to the target of interest.

9. A method of controlling an electronic therapy device for a therapy of a user of a computer mouse, wherein the computer mouse includes a main body, a power circuit, and a cursor control circuit electrically coupled to the power circuit, and the electronic therapy device has a plurality of electrodes and is pullably plugged into the main body of the computer mouse, comprising the steps of:
a. providing a function module electrically coupled to the power circuit of the computer mouse for generating a series of electronic pulses; and
b. activating the electronic therapy device so as to transmit a series of electronic pulses from the function module to at least one of the plurality of electrodes of the electronic therapy device to cause massage stimuli to the user on which the electronic therapy device is placed.

10. The method of claim 9, wherein the activating step comprises the step of electrically connecting the electronic therapy device to the function module.

11. The method of claim 9, further comprising the step of tuning a frequency of the series of electronic pulses generated by the function module.

12. The method of claim 9, further comprising the step of adjusting an intensity of the series of electronic pulses generated by the function module.

13. The method of claim 9, wherein the electronic therapy device is formed in a hand-like shape, whereby, in operation, the electronic therapy device simulates massages of a human hand.

14. The method of claim 13, further comprising the step of selecting a pattern massage the stimuli applied to the user.
